(19) United States
(12) Patent Application Publication
(10) Pub. No.: US 2025/0368187 A1
(43) Pub. Date: Dec. 4, 2025

(54) SYSTEMS AND METHODS TO FACILITATE VEHICLE PARKING

(71) Applicant: Ford Global Technologies, LLC, Dearborn, MI (US)

(72) Inventors: Dan Patrick Heaman, South Lyon, MI (US); Donald A. Perlick, Farmington Hills, MI (US)

(73) Assignee: Ford Global Technologies, LLC, Dearborn, MI (US)

(21) Appl. No.: 18/677,573

(22) Filed: May 29, 2024

(51) Int. Cl. B60W 30/06; B60W 50/14

(52) U.S. Cl. CPC B60W 30/06; B60W 2050/143; B60W 2420/403

(57) ABSTRACT

A vehicle including a sensor unit and a processor is disclosed. The sensor unit may be configured to capture sensor inputs associated with the vehicle's surroundings. The processor may be configured to determine that the vehicle is located at a predefined location, and determine a presence of an object in proximity to a predefined vehicle portion based on the sensor inputs responsive to determining that the vehicle may be located at the predefined location. The processor may further determine a distance between the predefined vehicle portion and the object based on the sensor inputs, responsive to determining the object presence. The processor may perform a remedial action responsive to determining that the distance may be equivalent to or approaching a preset buffer distance.

### FIELD

The present disclosure relates to systems and methods to facilitate vehicle parking in predefined parking locations.

### BACKGROUND

It is known that some users face inconvenience in parking their vehicles in garages or public parking lots. For example, a senior user may find it difficult to park the user's vehicle in an optimal position in a garage such that the vehicle's front and rear portions leave enough space from the garage's back wall and front door for the user to conveniently walk. Further, while parking in a parking lot, there may be instances where the vehicle may contact a parking barrier or block when, for example, the user does not correctly judge the distance between the vehicle's front or rear portion from the parking block.

Such instances may cause inconvenience to the user, and in some case may even result in affecting vehicle's exterior façade and/or vehicle performance.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to facilitate vehicle parking in accordance with the present disclosure.

FIG. 3 depicts a view of an example vehicle parked in a parking lot in accordance with the present disclosure.

FIG. 4 depicts a flow diagram of a method to facilitate vehicle parking in accordance with the present disclosure.

### DETAILED DESCRIPTION

### Overview

The present disclosure describes a vehicle that may be configured to assist a vehicle user in optimally parking the vehicle at a predefined parking location, e.g., a garage (or a parking lot the user may frequently visit). The vehicle may specifically assist the user in parking the vehicle in the garage such that a preset buffer distance may exist between a vehicle front portion and a garage back wall, and a vehicle rear portion and a garage front portion/door, when the vehicle may be parked at the garage. The preset buffer distance may be a user desired minimum distance between the vehicle's front/rear portion and the garage back wall/front door, so that the user may conveniently walk in the garage when the vehicle may be parked. The preset buffer distance may be adjustable/set by the user, and may be associated with the predefined parking location. In some aspects, the user may set different preset buffer distances for different parking locations, e.g., the garage, the parking lot, etc.

The vehicle may activate a “parking assist feature” when the vehicle may be located at the predefined parking location, e.g., the garage. Responsive to activating the parking assist feature, the vehicle may determine the distances between the vehicle front portion and the garage back wall, and the vehicle rear portion and the garage front portion/door, based on inputs obtained from a vehicle's sensor unit, when the user may be parking the vehicle in the garage. The vehicle may further compare the determined distance with the preset buffer distance. The vehicle may perform one or more remedial actions when the determined distance may be equivalent to or approaching the preset buffer distance.

In an exemplary aspect, as part of the remedial action, the vehicle may output an audio alert notification as the distance may be approaching the preset buffer distance, indicating to the user that the distance is getting closer to the user desired minimum distance, and hence the user should stop moving the vehicle. In some aspects, a sound pattern of the audio alert notification may be updated as the distance approaches (or is gradually getting close to) the preset buffer distance. For example, quiet times between beeps may gradually decrease until a solid tone is heard, as the distance approaches the preset buffer distance. Other similar sound pattern changes are within the scope of the present disclosure.

In another exemplary aspect, as part of the remedial action, the vehicle may autonomously stop the vehicle movement when the distance becomes equivalent to the preset buffer distance, indicating to the user that the vehicle should not be moved further.

The present disclosure discloses a vehicle that facilitates a user to conveniently park the vehicle at a predefined parking location such as a garage, a public parking lot, and/or the like. The vehicle enables the user to adjust/set a minimum distance that the user prefers to keep between the vehicle and the garage's back wall/front door, thereby considerably enhancing user's convenience of using the vehicle's parking assist feature. Further, the vehicle outputs the alert notification and/or autonomously stops the vehicle movement when the vehicle may be getting close to the garage's back wall/front door, thereby enabling the user to park the vehicle in an optimal position in the garage.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

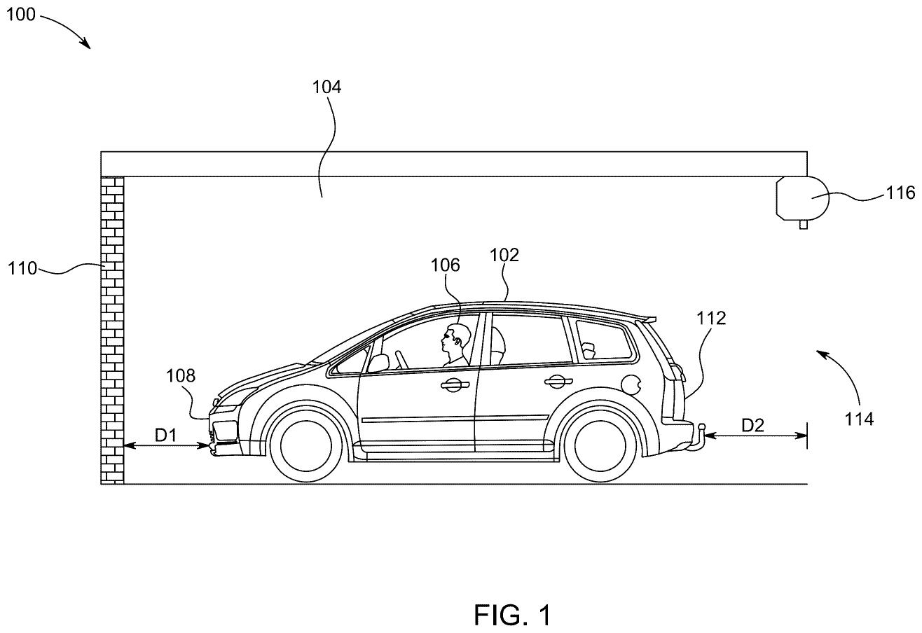

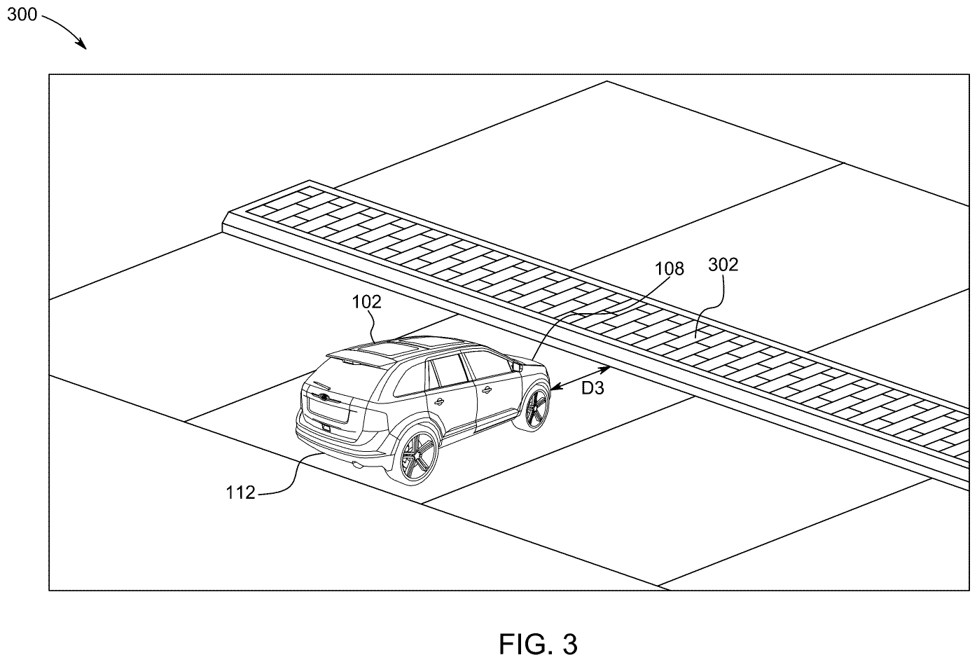

FIG. 1 depicts an example environment 100 in which techniques and structures for providing the systems and methods disclosed herein may be implemented. The environment 100 may include a vehicle 102 that may be located at or approaching a predefined parking location 104. In an exemplary aspect, the predefined parking location 104 may be a garage, as shown in FIG. 1. In other aspects, the predefined parking location 104 may be a public or office parking lot (as shown in FIG. 3, and described later in the description below) or any other designated parking space where a user 106 (who may be the vehicle owner and/or driver) may frequently park the vehicle 102. Hereinafter, the predefined parking location 104 is referred to as garage 104; however such terminology should not be construed as limiting.

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain such as a gasoline engine, one or more electrically-actuated motor(s), a hybrid system, etc.

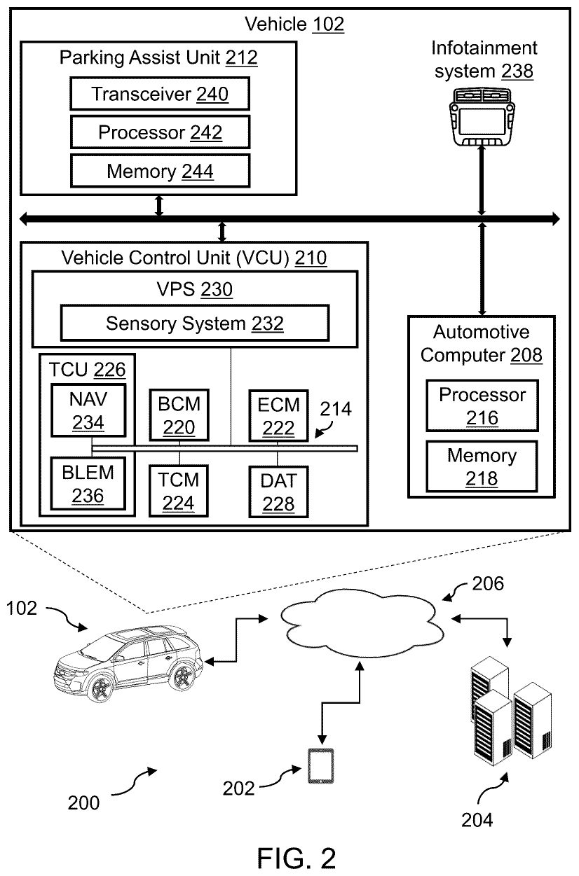

The vehicle 102 may be configured to enable the user 106 to conveniently park the vehicle 102 in the garage 104, such that a distance “D1” between a vehicle front portion 108 and a garage back wall 110, and a distance “D2” between a vehicle rear portion 112 and a garage front portion 114 (or a garage door 116 when the garage door 116 is closed) may be greater than or equivalent to a preset buffer distance, when the vehicle 102 is parked in the garage 104. The preset buffer distance may be adjustable or defined/set by the user 106 via, e.g., a user device (shown as user device 202 in FIG. 2) or a vehicle Human-Machine Interface (HMI, shown as infotainment system 238 in FIG. 2). The user 106 may set the preset buffer distance (e.g., 2 or 2.5 feet) such that there is enough space or room for the user 106 to conveniently walk in the garage 104 after the vehicle 102 has been parked. In some aspects, the user 106 may additionally provide information (e.g., geo-coordinates) associated with the garage 104 (or any other predefined parking location 104), so that the vehicle 102 uses the preset buffer distance to assist the user 106 in parking the vehicle 102 only when the vehicle is located at the garage 104 (or any other predefined parking location 104), and not otherwise. In alternative aspects, the vehicle 102 may use the preset buffer distance to assist the user 106 in parking the vehicle 102 in other parking locations as well, different from the predefined parking locations 104.

In some aspects, to assist the user 106 in conveniently parking the vehicle 102 in the garage 104 as described above, the vehicle 102 may track/monitor a real-time vehicle geolocation. Responsive to determining that the real-time vehicle geolocation matches with the garage geo-coordinates/location, the vehicle 102 may determine that the vehicle 102 may have reached the garage 104, and the user 106 may require parking assistance. Responsive to such determination, the vehicle 102 may activate a vehicle's parking assist feature. Stated another way, the vehicle 102 may activate the vehicle's parking assist feature when the vehicle 102 reaches the garage 104 (or any other predefined parking location 104).

The vehicle 102 may then fetch information associated with the preset buffer distance (that may be pre-stored by the user 106 in the vehicle 102) from a vehicle memory when the vehicle's parking assist feature may be activated. The vehicle 102 may further monitor a vehicle movement as the user 106 attempts to the park the vehicle 102 in the garage 104. Specifically, as the user 106 attempts to the park the vehicle 102, the vehicle 102 may determine the distances “D1” and “D2” based on sensor inputs obtained from a vehicle sensor unit (shown as vehicle sensory system 232 in FIG. 2). The vehicle 102 may then compare the distances “D1” and “D2” with the preset buffer distance.

The vehicle 102 may perform one or more predefined remedial actions when the distance “D1” or “D2” may be equivalent to or approaching the preset buffer distance, to alert the user 106 that the vehicle 102 is getting closer to the garage back wall 110 or the garage front portion 114 than the “user-desired minimum distance” (i.e., preset buffer distance). In an exemplary aspect, the vehicle 102 may commence to output an audio alert notification when the distance “D1” or “D2” may be approaching the preset buffer distance (e.g., when a difference between the distance “D1” or “D2” and the preset buffer distance may be decreasing below 50-80% of the preset buffer distance). As an example, the vehicle 102 may start to output the audio alert notification when the distance “D1” or “D2” may become equivalent to three feet and the preset buffer distance may be two feet. In some aspects, the vehicle 102 may cause a sound pattern of the audio alert notification to update/change as the distance “D1” or “D2” approaches the preset buffer distance, or as the difference between the distance “D1” or “D2” and the preset buffer distance tends to zero. For example, quiet times between beeps may gradually decrease until a solid tone is heard, as the distance “D1” or “D2” approaches the preset buffer distance. Other similar sound pattern changes are within the scope of the present disclosure. The vehicle 102 may continue to output the audio alert notification till the distance “D1” or “D2” becomes equivalent to the preset buffer distance (or in some aspects, even afterwards). In some aspects, the vehicle 102 may output one or more additional alert notifications on the vehicle HMI and/or the user device, along with the audio alert notification described above, till the distance “D1” or “D2” becomes equivalent to the preset buffer distance.

The user 106 may hear the audio alert notification and may accordingly stop the vehicle movement, so that the vehicle 102 is optimally parked (i.e., parked at a distance from the garage back wall 110 and the garage front portion 114 that is equivalent to or more than the preset buffer distance). In this manner, the vehicle 102 may assist the user 106 to optimally park the vehicle 102 in the garage 104. Since the preset buffer distance is set by the user 106 (i.e., the preset buffer distance is adjustable), the vehicle 102 enables the user 106 to park in the garage 104 as per user's requirements/preferences. Further, the user 106 may set different preset buffer distances for different predefined parking locations 104. For example, the user 106 may set two feet as the preset buffer distance when the vehicle 102 is expected to park in the garage 104, and one foot when the vehicle 102 is expected to park in a public parking lot. In the latter case, the vehicle 102 may output the audio alert notification till a distance between the vehicle front or rear portions 108, 112 and the parking barrier/block located in the public parking lot becomes equivalent to one foot, when the user 106 may be parking the vehicle 102 in the public parking lot.

In further aspects, the vehicle 102 may perform one or more additional remedial actions to assist the user 106 in parking the vehicle 102 in the garage 104 (or any other predefined parking location 104). For example, the vehicle 102 may autonomously stop a vehicle movement when the distance “D1” or “D2” becomes equivalent to the preset buffer distance, thereby providing an indication to the user 106 that the vehicle 102 is parked at an optimal position and the vehicle 102 should not be moved further. Stated another way, the vehicle 102 may autonomously stop moving when the distance “D1” or “D2” becomes equivalent to the user-desired minimum distance and may not enable the vehicle 102 to move any further closer to the garage back wall 110 or the garage front portion 114. In some aspects, the user 106 may override this autonomous vehicle movement stoppage feature. In this case, the vehicle 102 may limit powertrain torque to a very low value, regardless of the vehicle's pedal position, to prevent vehicle's contact with the garage back wall 110 (or the garage door 116, if the garage door 116 is closed).

Further vehicle details are described below in conjunction with FIG. 2.

The vehicle 102 and/or the user 106 implement and/or perform operations, as described here in the present disclosure, in accordance with the owner manual and safety guidelines. In addition, any action taken by the user 106 based on the notifications/recommendations provided by the vehicle 102 should comply with all the rules specific to the location and operation of the vehicle 102 (e.g., Federal, state, country, city, etc.). The notifications/recommendations, as provided by the vehicle 102, should be treated as suggestions and only followed according to any rules specific to the location and operation of the vehicle 102.

FIG. 2 depicts a block diagram of a system 200 to facilitate vehicle parking in accordance with the present disclosure. While describing FIG. 2, references will be made to FIG. 3.

The system 200 may include the vehicle 102, a user device 202 and one or more servers 204 (or a server 204) communicatively coupled with each other via one or more networks 206. The user device 202 may be associated with the user 106, and may be, for example, a mobile phone, a computer, a laptop, a smartwatch, a tablet, or any other device with communication capabilities. The server 204 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet. In further aspects, the server 204 may be configured to provide image processing algorithms to the vehicle 102, which may facilitate the vehicle 102 to analyze images and determine presence of one or more objects in the images. For example, the vehicle 102 may determine the presence of the garage back wall 110, the garage door 116, garage front portion 114, one or more items placed in the garage 104 in front of the garage back wall 110, and/or the like, by executing the image processing algorithms obtained from the server 204 on one or more garage images (that may be captured by vehicle cameras or vehicle's sensor unit). In one exemplary aspect, the garage back wall 110 may include two or more stickers (that may be pasted on the garage back wall 110), and the vehicle 102 may determine the positions of the stickers in the back wall images by executing the image processing algorithms on the back wall images. The vehicle 102 may then determine the presence of the garage back wall 110 and the distance “D1” based on the positions of the stickers in the back wall images. A person ordinarily skilled in the art may appreciate that the vehicle 102 may determine the distance “D1” provided that at least two stickers are visible in the back wall images. The server 204 may transmit the image processing algorithms to the vehicle 102 at a predefined frequency, or when the vehicle 102 transmits a request to the server 204 to obtain the image processing algorithms.

The network(s) 206 illustrates an example communication infrastructure in which the connected devices discussed in various embodiments of this disclosure may communicate. The network(s) 206 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 208, a Vehicle Control Unit (VCU) 210, and a parking assist unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 102, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a parking assist program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 102 systems, connected servers (e.g., the server(s) 204), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232 (or a “sensor unit”). The vehicle sensory system 232 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, ultrasonic sensors, temperature sensors, wheel sensors, ambient weather sensors, vehicle internal and external cameras, one or more rain sensors, capacitive moisture sensors, etc. In some aspects, the vehicle sensory system 232 may be configured to capture sensor inputs associated with a vehicle surrounding where the vehicle 102 may be located. In one exemplary aspect, the sensor inputs may be vehicle surrounding images (e.g., RGB images, 3D images, etc.) that the vehicle internal and external cameras, radar sensors, lidar sensors, and/or the like may capture, which may facilitate the vehicle 102 to determine presence of one or more objects in proximity to the vehicle 102 and/or object's distance from the vehicle 102. In another exemplary aspect, the sensor inputs may be inputs captured by the vehicle's proximity sensors, ultrasonic sensors, etc., which may facilitate the vehicle 102 to determine an object's distance from the vehicle 102.

In some aspects, the VCU 210 may control vehicle operational aspects and implement one or more instruction sets received from the user device 202, the server 204, from one or more instruction sets stored in the memory 218, including instructions operational as part of the unit 212.

The TCU 226 may be configured and/or programmed to provide vehicle connectivity to wireless computing systems onboard and off board the vehicle 102 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a key fob, not shown), computers, and modules. The TCU 226 may be in communication with the ECUs 214 by way of a bus. In some aspects, the TCU 226 may be configured to determine a real-time vehicle geolocation, e.g., based on signals obtained from the NAV receiver 234 and/or other transceivers described above.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device 202, the server(s) 204, among others.

The BCM 220 generally includes integration of sensors, vehicle performance indicators, and variable reactors associated with vehicle systems and may include processor-based power distribution circuitry that can control functions associated with the vehicle body such as lights, windows, security, camera(s), headlights, audio system(s), speakers, wipers, door locks and access control, and various comfort controls. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may be further configured to receive user instructions/inputs via the touchscreen interface portion, and/or display notifications/recommendations, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 102, may include a transceiver 240, a processor 242, and a computer-readable memory 244, which may be communicatively coupled with each other.

The transceiver 240 may be configured to receive information/inputs from one or more external devices or systems, e.g., the user device 202, the server(s) 204, and/or the like via the network 206. For example, the transceiver 240 may receive the image processing algorithms from the server(s) 204 via the network 206. Further, the transceiver 240 may transmit notifications (e.g., alert/alarm signals) to the external devices or systems. In addition, the transceiver 240 may be configured to receive information/inputs from vehicle 102 components such as the infotainment system 238, the vehicle sensory system 232, and/or the like. Further, the transceiver 240 may transmit notifications (e.g., alert/alarm/command signals) to the vehicle 102 components such as the infotainment system 238, the VCU 210, etc.

The processor 242 and the memory 244 may be the same as or similar to the processor 216 and the memory 218, respectively. In some aspects, the processor 242 may utilize the memory 244 to store programs in code and/or to store data for performing aspects in accordance with the disclosure. The memory 244 may be a non-transitory computer-readable medium or memory storing the parking assist program code.

In operation, the user 106 may “configure” the vehicle's parking assist feature on the vehicle 102, when the user 106 desires the vehicle 102 to assist the user 106 in parking the vehicle 102 in specific predefined locations or the predefined parking locations 104 described above in conjunction with FIG. 1. The predefined parking locations 104 may be the garage 104, a public parking lot 300 shown in FIG. 3, and/or the like. In some aspects, the user 106 may configure the vehicle's parking assist feature when the vehicle 102 may be located at the predefined parking location 104. In other aspects, the user 106 may configure the vehicle's parking assist feature when the vehicle 102 may be located away from the predefined parking location 104.

In some aspects, to configure the vehicle's parking assist feature, the user 106 may provide information associated with the predefined parking location 104 to the vehicle 102 via the user device 202 or the infotainment system 238. The information associated with the predefined parking location 104 may include predefined location geo-coordinates. For example, when the predefined parking location 104 is the garage 104, the user 106 may provide garage's geo-coordinates to the vehicle 102. In an exemplary aspect, when the user 106 may be configuring the vehicle's parking assist feature while the vehicle 102 is located at the garage 104, the user 106 may request the vehicle 102 to treat vehicle's current geo-coordinates as the predefined location geo-coordinates. In this case, the vehicle 102 may automatically determine the predefined location geo-coordinates based on the vehicle's current geo-coordinates. In other aspects, when the user 106 may be configuring the vehicle's parking assist feature while the vehicle 102 is located away from the garage 104, the user 106 may manually enter the predefined location geo-coordinates on the user device 202 or the infotainment system 238 via, e.g., a 3D digital map of a geographical area including the garage 104. The user 106 may follow a similar process of providing the predefined location geo-coordinates when the predefined parking location 104 may be the parking lot 300.

Responsive to the user 106 providing the information associated with the predefined parking location 104 to the vehicle 102 via the user device 202 or the infotainment system 238, the processor 242 may obtain the information and store the information in the memory 244. The information associated with the predefined parking location 104 may indicate to the processor 242 that the user 106 desires the vehicle 102 to activate the vehicle's parking assist feature whenever the vehicle 102 is located at the predefined parking location 104 (e.g., at the garage 104 or the parking lot 300).

The vehicle's parking assist feature may facilitate the user 106 to park the vehicle 102 in the garage 104 such that the distances “D1” and “D2” are greater than or equivalent to a first preset buffer distance (e.g., two feet), when the vehicle 102 is parked in the garage 104, as described above in conjunction with FIG. 1. Similarly, the vehicle's parking assist feature may facilitate the user 106 to park the vehicle 102 in the parking lot 300 such that a distance “D3” between the vehicle front portion 108 (or the vehicle rear portion 112) and a parking barrier or block 302 is greater than or equivalent to a second preset buffer distance (e.g., one foot), as shown in FIG. 3.

In some aspects, while configuring the vehicle's parking assist feature, in addition to providing the information associated with the predefined parking location 104, the user 106 may also provide information associated with the preset buffer distance to the vehicle 102 via the user device 202 or the infotainment system 238 for the predefined parking location 104. The preset buffer distance may be adjustable by the user 106 at any time via the user device 202 or the infotainment system 238, and may be associated with or linked with the predefined parking location 104. For example, the user 106 may set a preset buffer distance of two feet for the garage 104, and a preset buffer distance of one foot for the parking lot 300. The memory 244 may store a data structure or mapping between different predefined parking locations 104 and the corresponding preset buffer distances set by the user 106.

The description below is described in the context of the garage 104; however, the same description is also applicable to the scenario where the predefined parking location 104 is the parking lot 300.

When the vehicle 102 may be moving or approaching the predefined parking location 104 (e.g., the garage 104), the processor 242 may obtain the real-time vehicle geolocation from the TCU 226. The processor 242 may further compare the real-time vehicle geolocation with the information associated with the predefined parking location 104/garage 104 (i.e., the garage geo-coordinates), and determine that the vehicle 102 may be located at the garage 104 when the real-time vehicle geolocation matches with the garage geo-coordinates.

Although the description above describes an aspect where the processor 242 determines that the vehicle 102 may be located at the garage 104 by matching the real-time vehicle geolocation with the garage geo-coordinates, the present disclosure is not limited to such an aspect. In alternative or additional aspects, the processor 242 may determine that the vehicle 102 may be located at the garage 104 by matching the vehicle's surrounding images obtained from the vehicle sensory system 232 with one or more pre-stored garage images (e.g., by using the image processing algorithms obtained from the server 204). The processor 242 may determine that the vehicle 102 may be located at the garage 104 when the vehicle's surrounding images match with a pre-stored garage image. In some aspects, the garage images may be captured by the vehicle sensory system 232 and stored in the memory 244 when the user 106 may configuring the vehicle's parking assist feature. In other aspects, the user 106 may himself/herself provide the garage images to the vehicle 102 while configuring the vehicle's parking assist feature. In further aspects, the processor 242 may determine that the vehicle 102 may be located at the garage 104 by any other known means.

Responsive to determining that the vehicle 102 may be located at the garage 104, the processor 242 may activate the vehicle's parking assist feature. The processor 242 may then obtain the sensor inputs from the vehicle sensory system 232, and determine a presence of one or more objects in proximity to a predefined vehicle portion based on the sensor inputs, responsive activating the parking assist feature. Stated another way, the processor 242 may determine the object presence in proximity to the predefined vehicle portion based on the sensor inputs, as described herein, only when the parking assist feature is activated and not otherwise. Since the parking assist feature is activated when the vehicle 102 is located at the garage 104 (or the predefined parking location 104), a person ordinarily skilled in the art may appreciate that the processor 242 determines the object presence in proximity to the predefined vehicle portion based on the sensor inputs, as described herein, only when the vehicle 102 is located at the garage 104 (or the predefined parking location 104), and not otherwise.

In some aspects, the predefined vehicle portion may be the vehicle front portion 108 and/or the vehicle rear portion 112. Further, when the predefined parking location 104 is the garage 104, the objects described herein may include the garage back wall 110 (or two or more stickers pasted on the garage back wall 110) and the garage front portion 114 (or the garage door 116). When the predefined parking location 104 is the parking lot 300, the object may be the parking block 302.

In some aspects, while configuring the parking assist feature, the user 106 may additionally provide “identifiers” of one or more objects (e.g., the garage back wall 110, the garage front portion 114, the parking block 302, etc.) that the user 106 may desire the vehicle 102 to maintain a minimum distance from (i.e., maintain the preset buffer distance from), when the vehicle 102 may park at the predefined parking location 104. In an exemplary aspect, the identifiers may be object images, e.g., garage back wall images, garage front portion images, and/or the like, and may be part of the information associated with the predefined parking location 104 that the user 106 provides to the vehicle 102 (or the vehicle 102 automatically captures) during the parking assist feature configuration process.

In the case where the user 106 provides the object identifiers to the vehicle 102 as described above, the processor 242 may determine the presence of the objects in proximity to the vehicle front or rear portions 108, 112 by comparing (e.g., via the image processing algorithms) the object identifiers with the sensor inputs or real-time garage images captured by the vehicle sensory system 232 (e.g., by vehicle's cameras, radar sensors, lidar sensors, etc.). The processor 242 may determine that the object may be present in proximity to the vehicle front or rear portions 108, 112 when the object included in the real-time garage images match with the object identifiers. For example, the processor 242 may determine that the garage back wall 110 may be present in proximity to the vehicle front portion 108, when the garage back wall 110 is “visible” in the real-time garage images, determined based on the garage back wall 110 image that may have been provided by the user 106 during the parking assist feature configuration process (and then stored in the memory 244). As another example, the processor 242 may determine that the garage back wall 110 may be present in proximity to the vehicle front portion 108 when the stickers pasted on the garage back wall 110 may be visible in the real-time garage images.

The aspect, described above, of the user 106 providing the object identifiers to the vehicle 102 during the parking assist feature configuration process should not be construed as limiting and is not necessary for the parking assist feature to operate. The processor 242 may still determine (via the image processing algorithms obtained from the server 204) the object presence in proximity to the vehicle front or rear portions 108, 112 based on the real-time garage images captured by the vehicle sensory system 232, even if the user 106 does not provide the object identifiers to the vehicle 102 during the parking assist feature configuration process. In this case, the processor 242 may additionally or alternatively determine the object presence in proximity to the vehicle front or rear portions 108, 112 based on the sensor inputs obtained from the vehicle's proximity sensors, ultrasonic sensors, and/or the like.

Responsive to determining the object presence in proximity to the vehicle front or rear portions 108, 112, the processor 242 may determine the distances “D1” and “D2” (i.e., the distances between the vehicle front and rear portions 108, 112 with the detected objects, i.e., the garage back wall 110 and the garage front portion 114) based on the sensor inputs obtained from the vehicle sensory system 232. As described above, in an exemplary aspect, the processor 242 may determine the distance “D1” based on the locations of the stickers pasted on the garage back wall 110 in the real-time garage images. The processor 242 may further fetch the information associated with the preset buffer distance associated with the garage 104 (when the predefined parking location 104 is the garage 104 or when the vehicle 102 is located at the garage 104) from the memory 244. The processor 242 may then compare the distances “D1” and “D2” with the preset buffer distance associated with the garage 104, and may perform one or more remedial actions when the distances “D1” or “D2” may be equivalent to or approaching the preset buffer distance (e.g., when the user 106 may be attempting to park the vehicle 102 in the garage 104, as described above in conjunction with FIG. 1), determined based on the comparison.

A person ordinarily skilled in the art may appreciate from the description above that the preset buffer distance may be a user desired minimum distance between the vehicle front or rear portions 108, 112 (i.e., the predefined vehicle portion) and the garage back wall 110 and the garage front portion 114 (i.e., the detected object) when the vehicle 102 is parked at the garage 104. Therefore, the processor 242 performs the remedial actions when the distance “D1” or “D2” may be equivalent to or approaching the preset buffer distance, so that the user 106 does not unintentionally or inadvertently park the vehicle 102 in the garage 104 in a position where the distance “D1” or “D2” is less than the user desired minimum distance. In this manner, the processor 242 may facilitate the user 106 in optimally parking the vehicle 102 in the garage 104. In some aspects, when the predefined parking location 104 is the parking lot 300, the processor 242 may perform the remedial action(s) when the distance “D3” becomes equivalent to or is approaching the preset buffer distance, when the user 106 may be parking the vehicle 102 in the parking lot 300 in proximity to the parking block 302.

In an exemplary aspect, the processor 242 may perform the remedial action by outputting, via the infotainment system 238 or one or more vehicle speakers, an audio alert notification as the distance “D1” or “D2” approaches the preset buffer distance, as described above in conjunction with FIG. 1. In some aspects, the processor 242 may cause a sound pattern of the audio alert notification to change/update as the distance “D1” or “D2” approaches the preset buffer distance or is gradually tending towards the preset buffer distance, so that the user 106 may know that the distance “D1” or “D2” is getting closer to the user desired minimum distance, and hence the user 106 should stop the vehicle movement.

In some aspects, if the user 106 does not stop the vehicle movement as the distance “D1” or “D2” becomes equivalent to the preset buffer distance, the processor 242 may perform another remedial action. In this case, the processor 242 may autonomously stop (e.g., via the VCU 210) the vehicle movement when the distance “D1” or “D2” becomes equivalent to the preset buffer distance.

In some aspects, to ensure that the user 106 does not inadvertently exit the vehicle 102 while keeping the vehicle transmission in the drive mode when the processor 242 autonomously stops the vehicle movement as described above, the processor 242 may perform an additional check. Specifically, responsive to autonomously stopping the vehicle movement, the processor 242 may obtain inputs from the VCU 210 and determine/monitor whether the user 106 has opened a vehicle door (e.g., to exit the vehicle 102) and the vehicle transmission is in the drive mode. Responsive to determining that the user 106 has opened the vehicle door and the vehicle transmission is still in the drive mode, the processor 242 may output an alert notification via the infotainment system 238, the vehicle speakers, the user device 202, and/or the like, indicating to the user 106 that the vehicle transmission should be moved to the park mode as the vehicle 102 is parked in the garage 104. In this manner, the processor 242 facilities in ensuring that the vehicle transmission is not inadvertently left in the drive mode by the user 106, when the processor 242 autonomously stops the vehicle movement and the user 106 exits the vehicle 102. In alternative aspects, in this case the vehicle 102 may shift itself to park or perform other actions/steps to lock itself in position, in case the user 106 does not respond to the alert notification, or if the vehicle 102 does not output the alert notification to notify the user 106 (e.g., to not bother the user 106).

As described above in conjunction with FIG. 1, the user 106 may override the autonomous vehicle stoppage process, in which case the processor 242 may limit the powertrain torque to a very low value, regardless of the vehicle's pedal position, to prevent vehicle's contact with the garage back wall 110.

The vehicle 102 may provide one or more additional features to enhance user's convenience of using the parking assist feature. For example, if the image of the front of the garage back wall 110 is cluttered due to the presence of one or more items, the processor 242 may use 3D vision, inputs from radar, lidar sensors, etc. to detect/determine the actual distance between the vehicle front portion 108 and the garage back wall 110 to ensure that the vehicle 102 is at the proper depth in the garage 104 (in case the layout of clutter/items in front of the vehicle 102 changes). In this case, the stickers pasted on the garage back wall 110 may assist the processor 242 to determine the presence of the wall in the garage images, and determine the distance “D1”, even if the front of the garage back wall 110 is cluttered.

If increased clutter/items prevent the vehicle 102 from getting close to the garage back wall 110, the processor 242 may output a request notification (e.g., via the user device 202 and/or the infotainment system 238), requesting the user 106 to check for clearance to the garage front portion 114. The processor 242 may additionally transmit a request to the user 106 (e.g., via the user device 202 and/or the infotainment system 238) to check if the user 106 accepts to have the vehicle 102 parked closer to the objects in front of the vehicle 102 than had been originally programmed. The processor 242 may then enable vehicle movement if the user 106 confirms the request. In additional aspects, when the processor 242 detects presence one or more unexpected clutter/items (e.g., Christmas decoration boxes) in front of or in proximity to the garage back wall 110, the processor 242 may autonomously determine an optimal distance from the garage back wall 110 based on the preset buffer distance and the dimensions of the clutter/items (that the processor 242 may determine based on the real-time garage images), and cause the vehicle 102 to park in the garage 104 in proximity to the garage back wall 110 based on the optimal distance.

Furthermore, although the description describes an aspect where the user 106 provides information associated with the preset buffer distance to the vehicle 102, the present disclosure is not limited to such an aspect. In alternative aspects, the processor 242 may autonomously identify an “optimal” preset buffer distance for the garage 104, and store the optimal preset buffer distance in the memory 244. In this case, the processor 242 may obtain one or more garage images (e.g., 3D images) from the vehicle sensory system 232, when the garage door 116 may be closed and the vehicle 102 may be parked in the garage 104. The processor 242 may further determine the garage dimensions by executing the image processing algorithms on the obtained garage images. For example, the processor 242 may determine a garage's front-to-rear distance based on the garage images.

Responsive to determining the garage dimensions, the processor 242 may correlate the garage dimensions with the vehicle dimensions (e.g., the vehicle length, which may be pre-stored in the memory 244) to determine the optimal preset buffer distance based on the garage dimensions and the vehicle dimensions. The processor 242 may determine the optimal preset buffer distance such that the vehicle 102 may be parked in a center position between the garage's front and back portions, while keeping enough space/room for the user 106 to walk when the vehicle 102 may be parked in the garage 104.

Responsive to determining the optimal preset buffer distance as described above, the processor 242 may store information associated with the optimal preset buffer distance in the memory 244, and then use the optimal preset buffer distance whenever the user 106 attempts to park the vehicle 102 in the garage 104, as described above. In this manner, the processor 242 may enable the user 106 to park the vehicle 102 conveniently in the garage 104, even if the user 106 has not provided or set the preset buffer distance on the vehicle 102.

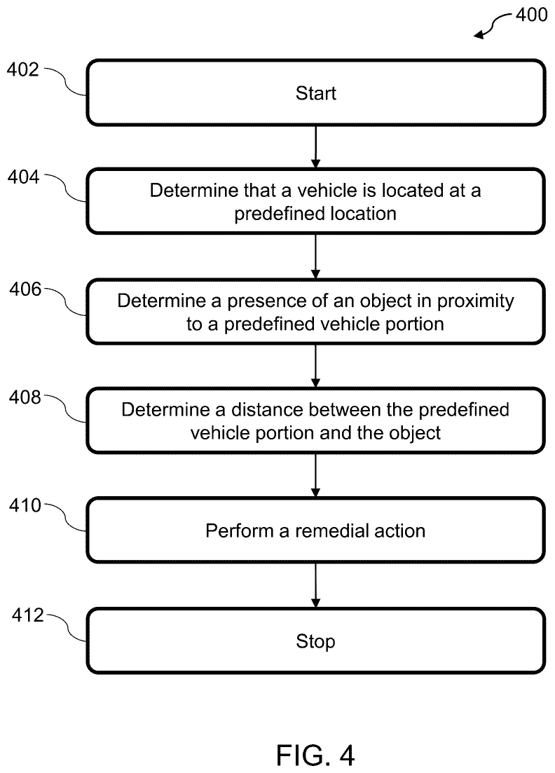

FIG. 4 depicts a flow diagram of a method 400 to facilitate vehicle parking in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include determining, by the processor 242, that the vehicle 102 may be located at the predefined parking location 104. At step 406, the method 400 may include determining, by the processor 242, the object presence in proximity to the predefined vehicle portion (e.g., the vehicle front or rear portions 108, 112) based on the sensor inputs obtained from the vehicle sensory system 232, responsive to determining that the vehicle 102 may be located at the predefined parking location 104.

At step 408, the method 400 may include determining, by the processor 242, the distances “D1” and “D2” based on the sensor inputs, responsive to determining the object presence. At step 410, the method 400 may include performing, by the processor 242, one or more remedial actions responsive to determining that the distances “D1” or “D2” may be equivalent to or approaching the preset buffer distance. The examples of the remedial actions are described above in conjunction with FIGS. 1 and 2.

The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a sensor unit configured to capture sensor inputs associated with the vehicle's surroundings; and
a processor communicatively coupled with the sensor unit, wherein the processor is configured to:
determine that the vehicle is located at a predefined location;
determine a presence of an object in proximity to a predefined vehicle portion based on the sensor inputs, responsive to determining that the vehicle is located at the predefined location;
determine a distance between the predefined vehicle portion and the object based on the sensor inputs; and
perform a remedial action responsive to determining that the distance is equivalent to or less than a preset buffer distance.

2. The vehicle of claim 1 further comprising a telematics control unit (TCU) configured to determine a real-time vehicle geolocation, wherein the processor determines that the vehicle is located at the predefined location based on the real-time vehicle geolocation obtained from the TCU.

3. The vehicle of claim 2, wherein the processor is further configured to:
obtain an information associated with the predefined location from a vehicle user;
compare the real-time vehicle geolocation with the information associated with the predefined location; and
determine that the vehicle is located at the predefined location when the real-time vehicle geolocation matches with the information associated with the predefined location.

4. The vehicle of claim 3, wherein the information associated with the predefined location comprises predefined location geo-coordinates.

5. The vehicle of claim 4, wherein the information associated with the predefined location further comprises an identifier associated with the object.

6. The vehicle of claim 1, wherein the processor is further configured to:
activate a parking assist feature in the vehicle responsive to determining that the vehicle is located at the predefined location; and
determine the presence of the object in proximity to the predefined vehicle portion responsive to activating the parking assist feature.

7. The vehicle of claim 1, wherein the predefined location is a garage, wherein the object is at least one of a garage back wall, a garage front door or a garage front portion, and wherein the predefined vehicle portion is at least one of a vehicle front portion or a vehicle rear portion.

8. The vehicle of claim 1, wherein the predefined location is a parking lot, wherein the object is a parking barrier or block disposed in the parking lot, and wherein the predefined vehicle portion is at least one of a vehicle front portion or a vehicle rear portion.

9. The vehicle of claim 1 further comprising a memory configured to store an information associated with the preset buffer distance, wherein the preset buffer distance is associated with the predefined location, and wherein the processor is further configured to:
fetch the information associated with the preset buffer distance from the memory responsive to determining that the vehicle is located at the predefined location;
compare the distance with the preset buffer distance; and
perform the remedial action based on the comparison.

10. The vehicle of claim 9, wherein the preset buffer distance is adjustable by a vehicle user via a user device or a vehicle Human-Machine Interface (HMI).

11. The vehicle of claim 1, wherein the processor performs the remedial action by outputting an audio alert notification, and wherein the processor is further configured to adjust a sound pattern of the audio alert notification as the distance approaches the preset buffer distance.

12. The vehicle of claim 1, wherein the processor performs the remedial action by autonomously stopping a vehicle movement when the distance is equivalent to the preset buffer distance.

13. The vehicle of claim 12, wherein the processor is further configured to:
determine that a vehicle user has opened a vehicle door and a vehicle transmission is in a drive mode, responsive to autonomously stopping the vehicle movement; and
output an alert notification responsive to determining that the vehicle user has opened the vehicle door and the vehicle transmission is in the drive mode.

14. The vehicle of claim 1, wherein the processor is further configured to:
obtain a predefined location image from the sensor unit;
determine predefined location dimensions based on the predefined location image;
determine an optimal preset buffer distance based on the predefined location dimensions; and
store information associated with the optimal preset buffer distance in a vehicle memory.

15. The vehicle of claim 1, wherein the sensor unit comprises at least one of a vehicle camera, a Radio Detection and Ranging (radar) sensor, or a Light Detection and Ranging (lidar) sensor, and wherein the sensor inputs comprise vehicle surrounding images.

16. The vehicle of claim 1, wherein the preset buffer distance is associated with a user desired minimum distance between the predefined vehicle portion and the object at the predefined location.

17. The vehicle of claim 1, wherein the processor is further configured to:
determine a presence of an item in proximity to the object;
determine an optimal distance between the predefined vehicle portion and the object based on the preset buffer distance and item dimensions; and
cause the vehicle to park in proximity to the object based on the optimal distance.

18. A parking assist method comprising:
determining, by a processor, that a vehicle is located at a predefined location;
determining, by the processor, a presence of an object in proximity to a predefined vehicle portion based on sensor inputs obtained from a sensor unit associated with the vehicle, responsive to determining that the vehicle is located at the predefined location;
determining, by the processor, a distance between the predefined vehicle portion and the object based on the sensor inputs; and
performing, by the processor, a remedial action responsive to determining that the distance is equivalent to or less than a preset buffer distance.

19. The parking assist method of claim 18, wherein the preset buffer distance is associated with the predefined location, and wherein the preset buffer distance is adjustable by a vehicle user via a user device or a vehicle Human-Machine Interface (HMI).

20. A non-transitory computer-readable storage medium having instructions stored thereupon which, when executed by a processor, cause the processor to:
determine that a vehicle is located at a predefined location;
determine a presence of an object in proximity to a predefined vehicle portion based on sensor inputs obtained from a sensor unit associated with the vehicle, responsive to determining that the vehicle is located at the predefined location;
determine a distance between the predefined vehicle portion and the object based on the sensor inputs, responsive to determining the presence of the object; and
perform a remedial action responsive to determining that the distance is equivalent to or approaching a preset buffer distance.
